(19) United States
(12) Patent Application Publication
(10) Pub. No.: US 2015/0152961 A1
(43) Pub. Date: Jun. 4, 2015

(54) METHOD AND APPARATUS OF PREVENTING UNINTENDED GEAR SELECTION IN A COMPOUND TRANSMISSION

(71) Applicant: Eaton Corporation, Cleveland, OH (US)

(72) Inventors: David M. Stevens, Athens, MI (US); Daniel Moreira, Santa Rita do Sapucaí (BR); Marcello Sagradi, Valinhos (BR); Joao Pinto, Valinhos (BR); Odilon V. Pinto, Valinhos (BR); Cory M. Burkey, Caledonia, MI (US)

(73) Assignee: Eaton Corporation, Cleveland, OH (US)

(21) Appl. No.: 14/096,280

(22) Filed: Dec. 4, 2013

(51) Int. Cl. F16H 61/16; F16H 59/02

(52) U.S. Cl. CPC F16H 61/16; F16H 59/02

(57) ABSTRACT

A compound transmission includes a protection mechanism, the mechanism includes a shift selector and a valve coupled to a first rail and, when the shift selector is positioned on the first rail, the valve is caused to be in a first position that allows shifting the transmission to a deep range operation.

### BACKGROUND

In operation of a heavy vehicle such as a truck, often the transmission is designed to operate in different ranges to accommodate various amounts of load or cargo and during different stages of acceleration. For example, in one known system an auxiliary shifter includes a deep range, a low range, and a high range, and the gears may be shifted through a number of gear positions, accordingly. In combination a wide range of gear ratios can thus be obtained to transition the vehicle from a stopped position and up through high speed operation such as on a highway.

In the deep range, used typically when under very heavy cargo load and when starting from stop, a very high-torque and low top-speed capability is provided to assist a driver to place the vehicle in motion without causing the vehicle to stall. Upon reaching the top speed of the deep range gear selection, the auxiliary shifter is shifted into a low range and the gears may be subsequently shifted through the sequence of gears. The auxiliary shifter is again shifted into the high range for yet additional gears at relatively high speeds of vehicle operation. The deep range may also be used for reverse, as well.

In one known embodiment a transmission is constructed using a 5-speed front box and a 3-speed auxiliary. As such, it is possible to achieve fifteen (15) forward gear position combinations by using all five front box gears in deep, low, and high range. In this known embodiment, however, the gear ratio steps for deep auxiliary are not designed to operate sequentially and in the positions on the 5-speed front box. In addition, the deep range auxiliary gear may not be designed to operate with increased duty cycle, but may be intended for use under heavy load when starting from stop.

Nevertheless, due to driver inexperience or despite instructions to the contrary, drivers may be prone to operating the transmission through the deep range, contrary to the design intent. That is, drivers may place the auxiliary shifter in deep range and then shift the gear shifter through its gears, using all five front box gears in the deep range, which can lead to premature wear and early life failure of the transmission.

Therefore, it is desirable to prevent driver selection of the deep range when using the front box gears.

### BRIEF DESCRIPTION OF THE DRAWINGS

Referring now to the drawings, illustrative examples are shown in detail. Although the drawings represent the exemplary illustrations described herein, the drawings are not necessarily to scale and certain features may be exaggerated to better illustrate and explain an innovative aspect of an exemplary illustration. Further, the exemplary illustrations described herein are not intended to be exhaustive or otherwise limiting or restricting to the precise form and configuration shown in the drawings and disclosed in the following detailed description. Exemplary illustrations of the present invention are described in detail by referring to the drawings as follows:

FIG. 1A is a representation of a vehicle having a compound transmission;

FIG. 1B illustrates a portion of the compound transmission;

FIG. 2 is an example of a single shift shaft type shifting mechanism;

FIG. 3 is a “repeat H” type control illustration for gear operation of the compound transmission;

FIG. 4 is a table illustrating rail, deep button, range button, and valve settings; and

FIG. 5 is symbolic illustration of elements of a protection mechanism for a compound transmission.

### DETAILED DESCRIPTION

Certain terminology will be used in the following description for convenience in reference only and will not be limiting. The words “upwardly”, “downwardly”, “rightwardly”, and “leftwardly” will designate directions in the drawings to which reference is made. The words “forward”, “rearward”, will refer respectively to the front and rear ends of the transmission as conventionally mounted in a vehicle, being respectively from left and right sides of the transmission.

The term “compound transmission” is used to designate a change speed or change gear transmission having a multiple forward speed main transmission section and a multiple speed auxiliary transmission section connected in series whereby the selected gear reduction in the main transmission section may be compounded by further selected gear reduction in the auxiliary transmission section. “Synchronized clutch assembly” and words of similar import shall designate a positive, jaw-type clutch assembly utilized to nonrotatably couple a selected gear to a shaft by means of a positive clutch in which attempted engagement of said clutch is prevented until the members of the clutch are at substantially synchronous rotation and relatively large capacity friction means are utilized with the clutch members and are sufficient, upon initiation of a clutch engagement, to cause the clutch members and all members rotating therewith to rotate at substantially synchronous speed.

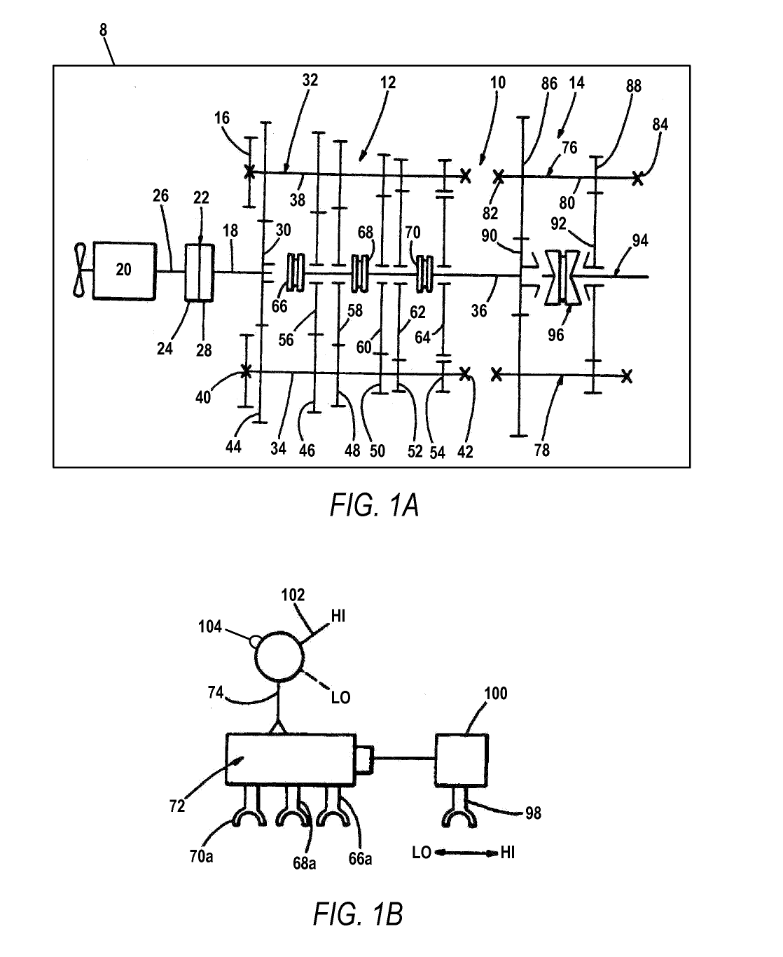

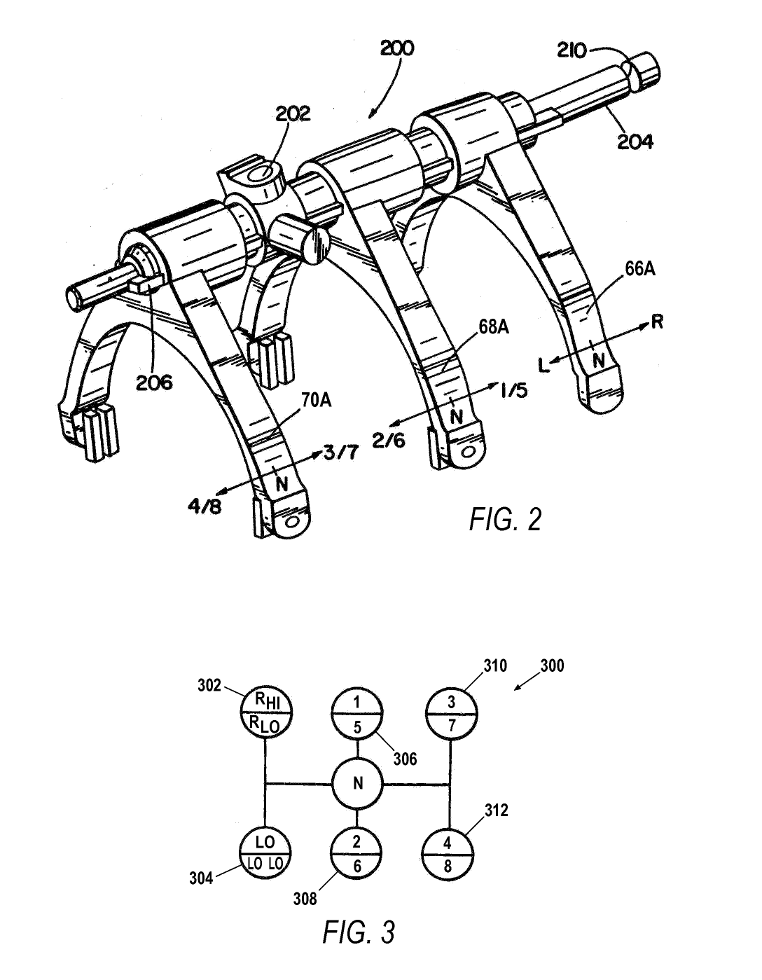

The terms “neutral” and “not engaged” are used interchangeably and refer to a main transmission section condition wherein torque is not transferred from the transmission input shaft to the main shaft (in transmissions of the general type illustrated in FIGS. 1A and 2). The terms “not neutral” and “engaged” may be used interchangeably and refer to a main transmission section condition wherein a main section drive ratio is engaged and drive torque is transferred from the transmission input shaft to the main shaft (in transmissions of the general type illustrated in FIGS. 1A and 2).

The term “high speed” ratio refers to that ratio of a transmission section wherein the rotational speed of the output is greatest for a given input rotational speed.

Referring to FIG. lA a vehicle 8 having a range type compound transmission 10 is illustrated, and the compound transmission is further illustrated in FIG. 1B. Compound transmission 10 comprises a multiple speed main transmission section 12 connected in series with a range type auxiliary section 14. Transmission 10 is housed within a housing 16 and includes an input shaft 18 driven by a prime mover such as diesel engine 20 through a selectively disengaged, normally engaged friction master clutch 22 having an input or driving portion 24 drivingly connected to the engine crankshaft 26 and a driven portion 28 rotatably fixed to the transmission input shaft 18.

In main transmission section 12, input shaft 18 carries an input gear 30 for simultaneously driving a plurality of substantially identical countershaft assemblies 32 and 34 at substantially identical rotational speeds. The two substantially identical countershaft assemblies 32, 34 are provided on diametrically opposite sides of a main shaft 36 which is generally coaxially aligned with input shaft 18. Each of the countershaft assemblies 32, 34 includes a countershaft 36 supported by bearings 38 and 40 in housing 16, only a portion of which is schematically illustrated. Each of the countershaft assemblies 32, 34 is provided with an identical grouping of countershaft gears 44, 46, 48, 50, 52 and 54, fixed for rotation therewith. A plurality of main shaft gears 56, 58, 60, 62 and 64 surround the main shaft 36 and are selectively clutchable, one at a time, to the main shaft 36 for rotation therewith by sliding clutch collars 66, 68 and 70 as is well known in the prior art. Clutch collar 66 may also be utilized to clutch input gear 30 to main shaft 36 to provide a direct drive relationship between input shaft 18 and main shaft 36.

Typically, clutch collars 66, 68 and 70 are axially positioned by means of shift forks 66A, 68A and 70A, respectively, associated with a shift housing assembly 72. Clutch collars 66, 68 and 70 may be of synchronized or non-synchronized double acting jaw clutch type.

Main shaft gear 64 is the reverse gear and is in continuous meshing engagement with countershaft gears 54 by means of conventional intermediate idler gears (not shown). It is contemplated that while main transmission section 12 does provide five selectable forward speed ratios, the lowest forward speed ratio obtained with the five selectable forward speed ratios, namely that provided by drivingly connecting main shaft drive gear 68 to main shaft 36, is often of such a high gear reduction it has to be considered a low or “creeper” gear which is utilized only for starting of a vehicle under severe conditions and is not usually utilized in the high transmission range. Further, as will be further discussed, a deep selector is further provided to provide yet lower gear operation for the low or “creeper” gear.

Jaw clutches 66, 68, and 70 are three-position clutches in that they may be positioned in the centered, nonengaged position as illustrated, or in a fully rightwardly engaged or fully leftwardly engaged position by means of a shift lever or selector 74. As is well known, only one of the clutches 66, 68 and 70 is engageable at a given time and main section interlock means (not shown) are provided to lock the other clutches in the neutral condition.

Auxiliary transmission range section 14 includes two substantially identical auxiliary countershaft assemblies 76 and 78, each comprising an auxiliary countershaft 80 supported by bearings 82 and 84 in housing 16 and carrying two auxiliary section countershaft gears 86 and 88 for rotation therewith. Auxiliary countershaft gears 86 are constantly meshed with and support range/output gear 90 which is fixed for rotation with main shaft 36 while auxiliary section countershaft gears 88 are constantly meshed with an output gear 92 which surrounds transmission output shaft 94.

A two-position synchronized jaw clutch assembly 96, which is axially positioned by means of a shift fork 98 and a range section shifting actuator assembly 100, is provided for clutching either gear 92 to output shaft 94 for low range operation or gear 90 to output shaft 94 for direct or high range operation of the compound transmission 10. A “repeat H” type shift pattern for compound range type transmission 10 is schematically illustrated in FIG. 1A. Selection of low or high range operation of the transmission 10 is by means of an operator actuated switch range selector 102 which is usually located at the shift lever 74, as well as a deep selector 104 for selecting a deep transmission operation or a non-deep operation, as will be further discussed.

Although the range type auxiliary section 14 is illustrated as a two-speed section utilizing spur or helical type gearing, it is contemplated that the present disclosure is also applicable to range type transmissions utilizing combined splitter/range type auxiliary sections, having three or more selectable range ratios and/or utilizing planetary type gearing. Also, any one or more of clutches 66, 68 or 70 may be of the synchronized jaw clutch type and transmission sections 12 and/or 14 may be of a single countershaft type.

The main transmission section 12 is controlled by axial movement of at least one shift rail or shift shaft contained within shift bar housing 72 and controlled by operation of shift lever 74. As is known, shift lever 74 may be mounted directly to, or remotely from, the transmission. The range section is controlled by operation of button 102, and operation in a “deep” mode is actuated using deep selector 104.

Referring to FIG. 2, an example of a single shift shaft type shifting mechanism 200 is illustrated. Shift lever 102 interacts with block member 202 to cause rotational or axial movement of shaft 204 relative to the transmission housing. Rotational movement will cause keys, such as key 206 and another unseen key, to interact with lands or slots provided in the hubs of the shift forks 66A, 68A and 70A to axially fix two of the shift forks relative to the housing and to axially fix the other shift fork to shaft 204. Axial movement of the shaft 204 and the selected shift fork axially fixed thereto will then result in engagement and disengagement of the jaw clutches 66, 68, 70 associated therewith. Accordingly, by monitoring of the axial position of a selected segment of shift shaft 204, such as one or more neutral detent notches 210, the in neutral-not in neutral condition of the main section 12 of transmission 10 may be sensed.

The present disclosure is also applicable to compound transmissions utilizing multiple parallel rail type shift bar housing assemblies. Such devices typically include an assembly extending perpendicular to the shift rails (often associated with a shift rail interlock mechanism) which will assume a first position when all of the shift rails are in an axially centered neutral position or a second position when any one of the shift rails is displaced from the axially centered neutral position thereof. The present disclosure is also applicable to compound transmissions wherein other mechanical, electrical, electromagnetic or other types of sensors are utilized to sense conditions indicative of transmission main section neutral (not engaged) or not neutral (engaged) conditions.

Although the auxiliary transmission sections are typically attached to the main transmission section, the term “auxiliary transmission section” as used herein is also applicable to detached drive train devices such as multiple-speed axles, multiple-speed transfer cases and the like. And, while the present disclosure is equally applicable to transmission 10 illustrated in FIG. 1A, as well as other compound transmissions utilizing synchronized auxiliary section jaw clutch assemblies, for purposes of simplification and ease of understanding, the present disclosure is described primarily as utilized with the compound range type transmission illustrated in FIG. 1A.

Assuming a shift control of the type illustrated in FIG. 3, i.e. a “repeat H” type control, a 4th-to-5th speed compound shift involves disengaging jaw clutch 66 from 4th/8th speed input gear 30, then disengaging clutch 96 from range low speed or reduction gear 90 and engaging clutch 96 with the high speed or direct range gear 92 and then engaging jaw clutch 68 with 1st/5th speed main section gear 60. To accomplish this, the vehicle operator will preselect “HI” with the range selector button 102, will shift from the 4/8 position to N and then to the 1/5 position with shift lever 72. In addition and as indicated, deep range operation may be activated by the vehicle operator by activating deep button 104.

Referring still to FIG. 3, a shift pattern 300 is illustrated in which low/hi reverse 302, Lo and “Lo Lo” 304, as well as gears 1-8 that are accomplished with combined operation of shift lever 74, range selector button 102, and deep button 104. As shown in FIG. 2, shift forks 66A-70A, otherwise referred to as rails, control operation of the various gear ratio combinations that can be accomplished. Operation between reverse 302 and Lo/“Lo Lo” 304 is accomplished on a first rail that corresponds to shift fork 66A, operation between gears 1/5 306 and gears 2/6 308 is accomplished on a second rail that corresponds to shift fork 68A, and operation between gears 3/7 310 and gears 4/8 312 is accomplished on a third rail that corresponds to shift fork 70A.

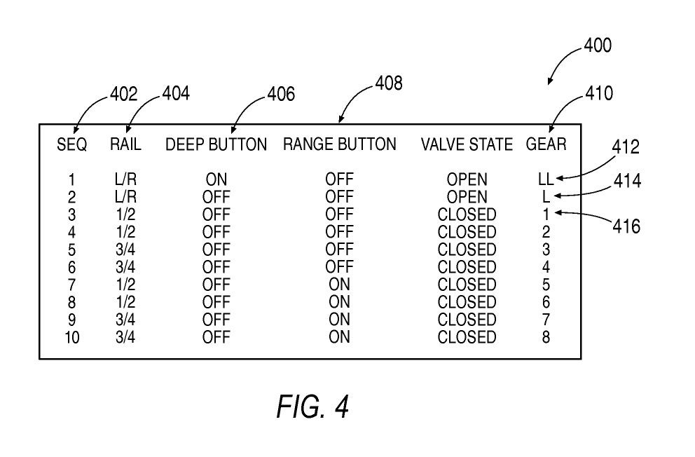

Operation between the gears and as described is summarized in table 400 illustrated as FIG. 4. A sequence 402 of ten forward gears is shown that corresponds to which rail 404 shifter 74 is positioned on, the deep button setting 406 that corresponds to deep button 104, and the range button setting 408 that corresponds to range button 102. For the various buttons and rails, a corresponding forward gear ratio is accomplished, as illustrated in gear column 410. As a first example, shown in the first row 412 of table 400 (corresponding to the first of sequence 402), “Lo Lo” operation (designated in the table as LL), is a lowest forward gear ratio for forward motion of the vehicle, and is accomplished by positioning shift lever 74 on first rail 66A and setting the selector also to the Lo/“Lo Lo” position 304, setting deep button 104 to its “on” position, and setting range button 102 to its “off” position. In such fashion, “Lo Lo” gear operation is achieved, which is the lowest forward gear ratio for transmission 10. As a next example at row 414, the second sequence step, shifting from “Lo Lo” operation to Lo operation, is accomplished by maintaining shift lever 74 at position 304, and maintaining range button 102 in “off”, and turning deep button 104 from “on” to “off”.

Shifting to first gear is at the third sequence step and shown in row 416. In this operation, shift lever 74 is repositioned to second rail 68A and moved forward to position 306. Deep button 104 is maintained in its “off” position, and range button 102 is maintained in its “off” position as well. When deep button 104 is in its “on” position, then the transmission is caused to operate in a low gear ratio, enabling a “Lo Lo” operation. The remaining gear selections continue up to 8^{th} gear by shifting to the different positions, and altering the range operation, as illustrated in Table 400. In such fashion, the sequence of steps 1-10 of column 402 is accomplished by selective fore and aft operation of shift lever 74, and selective operation of deep button 104 and range button 102. Thus, when shift lever or selector 74 is on first rail 66A such that the transmission is operated in the forward vehicle motion position, and deep selector 104 is on its non-deep setting (or off), then the transmission is in a forward operation having a gear ratio that is higher than when the transmission is in the lowest forward gear ratio. Further, range selector 102 includes a low setting (off) and a high setting (on), and when range selector 102 is in the low setting, forward transmission operation is at a lower gear ratio than when range selector 102 is in the high setting. However, although deep selector 104 controls shifting to the deep range or “Lo Lo” operation, when the valve is in the second position or closed, deep selector 104 is nevertheless moveable to the deep range operation, but shifting the transmission to the deep range operation is prevented or avoided due to the valve being in the second or closed position.

Deep operation is typically designed for limited use, such as reverse operation and for a deepest forward gear ratio operation. However and as stated, some vehicle operators may desire to maintain deep button 104 in its “on” position while shifting shift lever through positions 306, 308, 310, and 312. In effect, this operation would provide an additional set of gear options that are otherwise not available. That is, it is possible to achieve fifteen (15) forward gear position combinations by using all five front box gears in deep, low, and high range. The gear ratio steps for deep auxiliary are not designed to operate sequentially and in the positions on the 5-speed front box, and deep operation is not typically designed to handle the increased duty cycle. Nevertheless, due to driver inexperience or despite instructions to the contrary, drivers may be prone to operating the transmission through the deep range, contrary to the design intent. That is, drivers may place the auxiliary shifter in deep range and then shift the gear shifter through its gears, using all five front box gears in the deep range, which can lead to premature wear and early life failure of the transmission.

As summarized, the low and reverse gear positions 302, 304 are on the same rail 66A. Each rail 66A, 68A, and 70A is selected using a side to side movement of shift lever 74 that translates displacement through a shaft that is attached to the transmission. Thus, it is desirable to prevent selection of deep operation of deep selector 104 when the transmission is not on the L/R positions 302, 304.

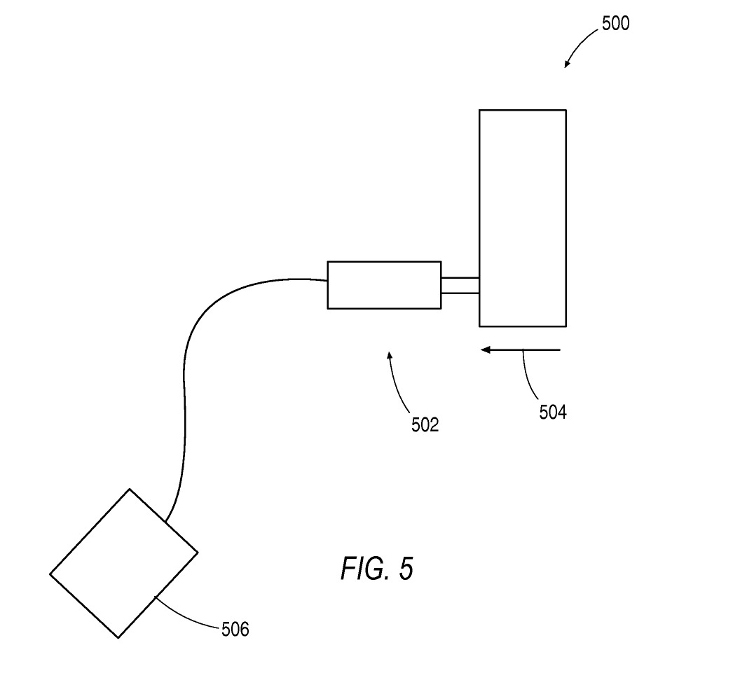

Referring to FIG. 5, a protection mechanism 500 for a compound transmission is illustrated. According to this embodiment, a valve 502 which, in one example is a pneumatic valve, is placed within the transmission and in one example is placed on an LRC. Valve 502 thus interfaces with a cross shaft of the LRC and is coupled to the first rail 66A such that when shift selector 74 is positioned 504 on the first rail 66A, the valve is caused to be in a first position that allows shifting the transmission to a deep range operation. That is, valve 502 is connected in series with a deep range pilot air signal that is used to actuate a deep range cylinder valve 506 and effectively shift the auxiliary to deep range. Valve 502 in one example is operable pneumatically such as by air pressure that is transmitted via a passageway such as a hose or other air transmission device to cause a mechanical motion. In other words, typically deep operation is achieved by actuating deep button 104, which actuates deep range cylinder valve 506 and enable deep operation. However, according to one illustrative approach, valve 502 provides operation indicative of whether shift selector 74 is on the first rail 66A, and activation of valve 502 thereby allows actuation of deep range cylinder valve 506 when valve 502 is in an open state. However, valve 506 is coupled to the rails in such a fashion that when shift selector 74 is not on the first rail 66A (i.e., in a second position different from the first position), then valve 502 is in a closed state—thus preventing actuation of deep range cylinder valve 506 and preventing transmission deep operation.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

Reference in the specification to “one example,” “an example,” “one approach,” or “an application” means that a particular feature, structure, or characteristic described in connection with the example is included in at least one example. The phrase “in one example” in various places in the specification does not necessarily refer to the same example each time it appears.

What is claimed is:

1. A compound transmission having a protection mechanism, comprising a shift selector and a valve coupled to a first rail and, when the shift selector is positioned on the first rail, the valve is caused to be in a first position that allows shifting the transmission to a deep range operation.

2. The transmission of claim 1, further comprising a deep selector positioned on the shift selector, the deep selector having a deep setting and a non-deep setting, wherein when:
the shift selector is on the first rail such that the transmission is operated in a forward vehicle motion position; and
the deep selector is on the deep setting;
then the transmission is in the transmission deep range operation and the transmission is in a lowest forward gear ratio.

3. The transmission of claim 2, wherein when:
the shift selector is on the first rail such that the transmission is operated in the forward vehicle motion position; and
the deep selector is on the non-deep setting;
then the transmission is in a forward operation having a gear ratio that is higher than when the transmission is in the lowest forward gear ratio.

4. The transmission of claim 2, further comprising a range selector positioned on the shift selector, wherein the range selector comprises a low setting and a high setting, and when the range selector is in the low setting, forward transmission operation is at a lower gear ratio than when the range selector is in the high setting.

5. The transmission of claim 1, comprising a second rail and, when the shift selector is on the second rail, the valve is caused to be in a second position that prevents the transmission deep range operation.

6. The transmission of claim 5, further comprising a deep selector that controls the shifting to the deep range operation, wherein when the valve is in the second position, the deep selector is moveable to the deep range operation but shifting the transmission to the deep range operation is prevented due to the valve being in the second position.

7. The transmission of claim 5, further comprising a third rail;
wherein:
the second rail includes a first forward gear setting and a second forward gear setting;
the third rail includes a third forward gear setting and a fourth forward gear setting, and the gear selector is positionable on the third rail; and
the shift selector is positionable in fore and aft positions on the first and second rails to shift the transmission to the first, second, third, and fourth settings.

8. A method of manufacturing a protection mechanism for a compound transmission, comprising:
coupling a valve to a first rail of the transmission; and
coupling the valve to a deep selector such that when the transmission is on the first rail, the valve is in a state of operation that allows the transmission to be shifted to a deep operation via the deep range selector.

9. The method of claim 8, further comprising:
providing a shift selector having the deep selector positioned thereon;
wherein when:
the shift selector is on the first rail such that the transmission is operated in a forward vehicle motion position; and
the deep selector is on a deep setting;
then the transmission is in the deep operation and the transmission is in a lowest forward gear ratio.

10. The method of claim 9, wherein when:
the shift selector is on the first rail such that the transmission is operated in the forward vehicle motion position; and
the deep selector is on a non-deep setting;
then the transmission is in a forward operation having a gear ratio that is higher than when the transmission is in the lowest forward gear.

11. The method of claim 9, further comprising positioning a range selector on the shift selector, wherein the range selector comprises a low setting and a high setting, and when the range selector is in the low setting, forward transmission operation is at a lower gear ratio than when the range selector is in the high setting.

12. The method of claim 8, further comprising providing a second rail and, when the shift selector is on the second rail, the valve is caused to be in a second position that prevents the deep operation.

13. The method of claim 8, further comprising providing a deep selector that controls the shifting to the deep operation, wherein when the valve is in the second position, the deep selector is moveable to the deep operation but shifting the transmission to the deep operation is prevented due to the valve being in the second position.

14. A vehicle, comprising:
a shift selector;
a compound transmission having a first rail; and
a protection mechanism for the compound transmission, comprising:
a valve coupled to the first rail and, when the shift selector is positioned on the first rail, the valve is caused to be in a first position that allows shifting the transmission to a deep range operation.

15. The vehicle of claim 14, further comprising a deep selector positioned on the shift selector, the deep selector having a deep setting and a non-deep setting, wherein when:
the shift selector is on the first rail such that the transmission is operated in a forward vehicle motion position; and
the deep selector is on the deep setting;
then the transmission is in the transmission deep range operation and the transmission is in a lowest forward gear.

16. The vehicle of claim 14, wherein when:
the shift selector is on the first rail such that the transmission is operated in the forward vehicle motion position; and
the deep selector is on the non-deep setting;
then the transmission is in a forward operation having a gear ratio that is higher than when the transmission is in the lowest forward gear.

17. The vehicle of claim 15, further comprising a range selector positioned on the shift selector, wherein the range selector comprises a low setting and a high setting, and when the range selector is in the low setting, forward transmission operation is at a lower gear ratio than when the range selector is in the high setting.

18. The vehicle of claim 14, wherein the transmission further comprises a second rail and, when the shift selector is on the second rail, the valve is caused to be in a second position that prevents the transmission deep range operation.

19. The vehicle of claim 18, further comprising a deep selector that controls the shifting to the deep range operation, wherein when the valve is in the second position, the deep selector is moveable to the deep range operation but shifting the transmission to the deep range operation is prevented due to the valve being in the second position.

20. The vehicle of claim 18, wherein the transmission further comprises a third rail;
wherein:
the second rail includes a first forward gear setting and a second forward gear setting;
the third rail includes a third forward gear setting and a fourth forward gear setting, and the gear selector is positionable on the third rail; and
the shift selector is positionable in fore and aft positions on the first and second rails to shift the transmission to the first, second, third, and fourth settings.
